(19) United States
(12) Patent Application Publication
(10) Pub. No.: US 2020/0172012 A1
(43) Pub. Date: Jun. 4, 2020

(54) Sneaky Peek :: Truck Safety Apparatus and Method

(71) Applicant: Jeffrey R. Pincheon, Sebastian, FL (US)

(72) Inventor: Jeffrey R. Pincheon, Sebastian, FL (US)

(21) Appl. No.: 16/205,263

(22) Filed: Nov. 30, 2018

(51) Int. Cl. B60R 1/00; H04W 4/48; H04N 5/225; H04N 7/18; B60R 11/04

(52) U.S. Cl. CPC B60R 1/00; H04W 4/48; B60R 2011/004; H04N 7/185; B60R 11/04; H04N 5/2252

(57) ABSTRACT

A controller, a power source, an antenna and a camera are in electronic communication with each other and are mounted within a rear guard wrapping frame. The camera housing is designed to be attached to various structural members at various portions of a truck or trailer. A trucker console has a processor, power source antenna and video display so that information sent from the camera in the wrapping frame is shaped by the controller and transmitted under its direction using the antenna of the camera housing. A corresponding antenna in the trucker console receives this information wherein which it is processed by a processor in the trucker console and displayed in a video display of the trucker console.

### FIELD OF THE INVENTION

The present invention relates to devices that communicate through electromagnetic waves; more particularly, the present invention relates to a method and apparatus that communicate using Wi-Fi® fi devices for truck safety and more broadly devices that communicated via electromagnetic waves using RF or similar transmission spectra.

### BACKGROUND OF THE INVENTION

In the late nineteenth century, Heinrich Hertz built the first antenna to harness this unique interaction and revolutionized communication which up until then was trapped into Wi-Fi® red transmission of information as found in the telegraph. As a result, the antenna can now be found in virtually all areas of modern life including television, cell phone, satellites, radio and in computer technologies such as Wi-Fi®, BLUETOOTH and so forth. What Hertz realized was that when an electromagnetic wave propagates through space it sometimes encounters a conductor having electric currents flowing therethrough; as it passes, the conductor current is affected by the power of this wave and this stimulus can be utilized to effect transport of information.

In order to effect communication a user has both a transmitter and a receiver, or alternatively, a transceiver integrally comprising both transmitted and receiver. To effect transmission, a control device transmits power to a set of antenna terminals and as a result electromagnetic waves are radiated outwards representative of the characteristics of the current power supplied thereto. In order to receive a signal, a receiver captures some of the power of an incoming electromagnetic wave and processes it through a controller to translate information from the wave; in this process, the incoming signal must be usually amplified and even sometimes filtered for noise and similar transient effects.

### PRIOR ART—UNITED STATES PATENTS & APPLICATIONS

U.S. Pat. No. 9,712,733 to Cao teaches a Method and Apparatus for Live Capture Image-Live Streaming Camera. In particular, Cao teaches live image transferring method includes the steps of capturing live image information by one or more live image devices, wherein the live image information is captured in raw format and is continuously transferred to one or more platforms in a live manner; cloning the live image information at the platform, wherein when the live image information is cloned at the platform, the live image information is converted from the raw format into a web viewable format and an embed code is generated corresponding to the live image information at the same time; and enabling one or more users to use the embed code in order to broadcast the live image information over any website. The user is able to copy-and-paste the embed code at the personal website to live stream the live image information from the live image device.

U.S. Pat. No. 8,689,249 to Pino et al. teaches an In-Home Monitoring Method and System Having a Video Camera Connected to a Set-Top Box. In particular, Pino teaches a method of receiving digital television programming content from a television service provider, receiving a first user input of a selected digital television programming content, receiving a message from a system, in response to receiving the message, causing a notification to be displayed on the television as an overlay over the displayed television programming content, receiving a first user command, determining a first control message to transmit to the system in response to receiving the first user command, transmitting the first control message. Also provided is a system including a video camera, an entry way security system, an HVAC system, a lighting system, an alarm system, or other system. User inputs may be received via a remote control to a set top box or from a computing device at a remote computer system through the internet and/or a mobile telephone network.

U.S. Pat. No. 9,600,065 to Tanaka teaches a Digital Camera with Communication Function. In particular, Tanaka teaches a digital camera having a wireless communicator with a server, a storage controller treats full size image data and display size image data unequally if the full size image data has been already sent to the server. For example, the display size image data is not allowed to be replaced by new digital image data unless the digital camera is not in use over a prescribed time. Own image data and other's image data are treated equally. Image data received from outside and retrieved from inside memory are treated equally. Search key for own image data and related search keys existing in the outside are indicated in a comparable manner. The digital camera receives search key from neighboring advertiser to send it for Internet search of advertisement. Search key received from neighboring notable site is sent for Internet search of photographs of the notable site taken by others.

U.S. Pat. No. 9,769,420 to Moses teaches a Portable Wireless Remote Monitoring and Control Systems. In particular, Moses teaches a user-programmable portable wireless remote monitoring system includes a base unit, a series of sensor units and a remote control device. The base unit is connected to the internet, and receives wireless alerts from sensor arrays deployed in the sensor units. When the sensor units detect a problem, then they send an alert to the base unit, which then relays the alert to the remote control device that is preferably a smart phone, tablet, or the like, including software for operating the system. The system may also incorporate smart outlets that are remotely operable by the remote control device, various monitors, a touchscreen, and wearable tracking devices to monitor a person within the home. The system is designed to provide security, home system monitoring, personal medical monitoring, and remote control of various electrical appliances. The system may also be controlled by using oral commands.

US20140047143 to Batemen et al. teaches Wireless Video Camera and Connection Methods including a USB Emulation. In particular, Batemen teaches systems and methods for connecting wireless cameras are provided. A computing device may include a network interface, and a processor configured to establish a virtual USB bus available to an operating system of the computing device, establish a virtual USB camera device, and report to the operating system that the virtual USB camera device is connected to the virtual USB bus. The virtual USB camera may be configured to establish a network connection to a network camera using the network interface, receive video data from the network camera via the network interface, and send the video data via the virtual USB bus. Alternatively, the virtual USB camera may send the video data to the operating system as USB packets, without establishing a virtual USB bus.

US Patent Application No. US20130208109 to Landry teaches: A Wireless Security Camera System. In particular, Landry teaches a security camera system, comprising wireless communication components for communicating over first and second wireless communications, and a digital camera system. A data processing system implements a method for providing digital images to an image receiving system. The method includes: establishing a first wireless connection between the security camera system and an external electronic device using the first wireless communication system. Configuration information pertaining to the second wireless communication system is transmitted from the security camera system to the external electronic device using the first wireless connection. Instructions for configuring the security camera system to communicate using the second wireless communication system are transmitted by the external electronic device to the security camera system over the first wireless connection. Captured digital images are then transmitted to the image receiving system over the second wireless communication system.

### Wi-Fi®

With the advent of computing devices a need was felt for wireless communication between various types of processing systems. As a result, a standard known as Wi-Fi® was developed to create wireless connections to local area networks. Amongst the devices using this type of communication are phones, games devices, tablets, cameras, TVs, printers, and audio video devices.

To more broadly use Wi-Fi®, a Wi-Fi® enabled product may connect to the internet using a hotspot; this typically has a range of about a seventy feet inside a structure and more when outdoors. Further, the Wi-Fi® range is extendible even to many kilometers by using multiple different types of access points combined together in a local network. Thus Wi-Fi® has extended around the world making it more simple for users having multiple types of devices from different manufacturers to access data across local networks and the internet.

In so doing, a user activates his personal device to enable Wi-Fi® thereby gaining access to a local network and thereby receive benefits therefrom. However, along with its robust data trove comes a difficult problem to overcome, namely, anyone can be a user and can login to the network. Thus, Wi-Fi® is vulnerable to attack by hackers or those who attempt denial of service attacks for amusement or for more criminal purposes. The reaction to this has been the development of Wi-Fi® Protected Access to secure the data moving across the network; thus, various types of protocols exist in order to encrypt or password protect the information transmitted wirelessly. However, Wi-Fi® remains a vulnerable system due to the fundamental nature of it operation.

### Wi-Fi® Ad-Hoc Mode

Wi-Fi nodes operating in ad-hoc mode refers to devices talking directly to each other without the need to first talk to an access point (also known as base station).

### Rear Truck Crash Protection

Various types of trailers and semi-trailers are required by the Federal Government to be equipped with what are known as Rear Impact Guards as shown in FIG. 1. These rear impact guards are a horizontally disposed member supported by one or more vertical members that are fixedly attached, welded or otherwise permanently mounted to the rear portion of a trailer or semi.

Additionally, associated support members are added and disposed diagonally or at various support angles to accomplish the purpose of providing a proper guarding mechanism. These associated support members can be similarly attached to the back of the semi or trailer or between the vertical member and the horizontal member or between the horizontal member and the underside of the trailer or semi and various other layouts are possible.

In order to ensure the viability of this system, the rear impact guards must meet certain specific guidelines promulgated by the USDOT (the United States Department of Transportation). The USDOT delineates these regulations through the Federal Motor Vehicle Safety Standard that have an effective date of the manufacture of the vehicle. It should be noted that these rear impact guards are a must because according to statistics and theory, there addition to the trailer or semi would lessen death and serious harm that results from smaller vehicle impacting the rear portion of these vehicles.

### Problems in the Current State of Rear Truck Crash Protection

In light of the foregoing, a problem has arisen in that truckers are unable to track what is happening at the rear of the trailer or semi as they are not equipped with video cameras. Most automotive vehicles such as Chevrolet®, Cadillac®, BMW®, Toyota®, Mercedes-Benz® and others have standard rear looking cameras integrally formed therein or have these as an option on an equipment package.

However, trucks present a unique problem in that they currently do not have this option. Freight trucks are especially handicapped in that to haul freight, a trucker picks up and drops off multiple trailers in a given time frame none of which are equipped with a rear facing camera. Thus, the truck does not have access to any type of rear camera whilst moving in reverse, driving on a highway where access to rear looking camera would be advantageous to assist a trucker in changing driving conditions. Because of this a solution that easily overcomes this problem with existing trucks is needed. It must easy to deploy, manufacture and simple to maintain and operate.

### SUMMARY OF THE INVENTION

The present invention overcomes the deficiencies of the known art and the problems that remain unsolved by providing a Sneaky Peek: Truck Safety Apparatus and Method.

A vehicle camera carrier comprising:
a housing having:
a camera rigidly disposed within the housing; wherein the housing is removably attachable to a portion of a vehicle and wherein the housing is not an original integral portion of the vehicle.

In another aspect, further comprising:
wherein the housing is a truck rear guard wrapping frame;
a first fastener attached at a first portion of the truck rear guard wrapping frame.

In another aspect, wherein the first fastener further comprises a fastener from a set of fasteners of: a button, a piece of velcro, a snap, links, jewelry hooks, carabiner type locking mechanisms.

In another aspect, further comprising:
a controller mounted in the housing in communication with the camera.

In another aspect, further comprising:
a battery mounted in the housing in communication with the camera.

In another aspect, further comprising:
an antenna mounted in the housing in communication with the camera.

In another aspect, wherein the antenna is from a set of antennas: a Wi-Fi® antenna, a BLUETOOTH® antenna, a RF antenna.

A trucker console comprising:
a video display selectively actuated by
a processor in electronic communication with
an antenna; such that the video display, processor and antenna are powered by a battery wherein the antenna actuated by the processor communicates with a truck remote camera housing.

In another aspect, wherein the antenna is from a set of antennas: a Wi-Fi® antenna, a BLUETOOTH® antenna, a RF antenna.

In another aspect, wherein the trucker console is from a set of consoles: a mobile device, a tablet, a standalone computer with dedicated software.

A method of operating a portable video system comprising the steps of:
synchronizing communication between a truck console and a removably attachable camera housing;
waking a camera in the camera housing;
collecting a video information frame using the camera.

In another aspect, further comprising the steps of:
storing the video information frame in a local memory of the removably attachable camera housing.

In another aspect, further comprising the steps of:
transmitting the the video information frame using an antenna of the camera housing.

In another aspect, further comprising the steps of:
determining if communication is still active between the truck console and the camera housing.

In another aspect, further comprising the steps of:
repeating the collecting video information frame and transmitting video information frame steps if the determining if communication is still active between the truck console and the camera housing indicates that communication is still active.

In another aspect, further comprising the steps of:
the truck console receiving the video information frame.

In another aspect, further comprising the steps of:
displaying the video frame on a video screen associated with the Truck Console.

In another aspect, further comprising the steps of:
transmitting from the truck console to the wrapping frame an OK next frame signal.

In another aspect, further comprising the steps of:
receiving in the camera housing an OK next frame signal.

In another aspect, further comprising the steps of:
repeating the collecting video information frame and transmitting video information frame steps.

These and other aspects, features, and advantages of the present invention will become more readily apparent from the attached drawings and the detailed description of the preferred embodiments which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a prior art image of a truck with a closeup view of the rear guards present at the end of the truck trailer as taught in an embodiment disclosed herein.

FIG. 2A presents a view of a Sneaky Peek mount formed as a wrapping frame as taught in an embodiment disclosed herein.

FIG. 2B presents a rear view of a trailer of the Sneaky Peek mount formed as a wrapping frame as taught in an embodiment disclosed herein.

FIG. 2C presents a front perspective view of a Sneaky Peek mount formed as a rigid housing in an alternative embodiment disclosed herein.

FIG. 2D presents a front view of a Sneaky Peek mount formed as a rigid housing attached by velcro on the bottom of the rigid housing to the back bumper of a trailer in an alternative embodiment disclosed herein.

FIG. 2E presents a back view of a Sneaky Peek mount formed as a rigid housing having a velcro strip attached to the back of the rigid housing in an alternative embodiment disclosed herein.

FIG. 2F presents a view of the Sneak Peek mount formed as a rigid housing having a velcro strip attached to the back of the rigid housing as it attaches to a front of a truck bumper in an alternative embodiment disclosed herein.

FIG. 2G presents a view of the Sneak Peek mount formed as a rigid housing having a velcro strip attached to the back and bottom of the rigid housing as it attaches to a rear of a trailer and to a ledge underneath a set of doors in an alternative embodiment disclosed herein.

FIG. 2H presents a view of the Sneak Peek mount formed as a rigid housing having a velcro strip attached to the bottom of the rigid housing as it attaches to an underside of the rear of a trailer in an alternative embodiment disclosed herein.

FIG. 2I presents a view of the Sneak Peek mount formed as a rigid housing having a velcro strip attached to the back of the rigid housing as it attaches to a depression in the front bumper of a truck in an alternative embodiment disclosed herein.

FIG. 2J presents a view of the Sneak Peek mount formed as a rigid housing having a velcro strip attached to the back of the rigid housing as it attaches to a side panel of a truck in an alternative embodiment disclosed herein.

FIG. 3 presents a high level view of the Sneaky Peek electronic module that is disposed within the Sneaky Peek Mount of FIG. 2A-2J as taught in an embodiment herein disclosed.

FIG. 4 presents a high level view of the Truck Console that communicates with the Sneaky Peek Module as taught in an embodiment herein disclosed.

FIG. 5 presents a high level flowchart of the various steps involved in initiating communication between the Sneaky Peek and the Truck Console as taught in an embodiment herein disclosed.

FIG. 6 presents a high level flowchart of the various steps involved in gathering images at the Sneaky Peek and preparing them for transmission to the Truck Console as taught in an embodiment herein disclosed.

FIG. 7 presents a high level flowchart of the various steps involved in receiving images at the Truck Console and Displaying the aforementioned as taught in an embodiment herein disclosed.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

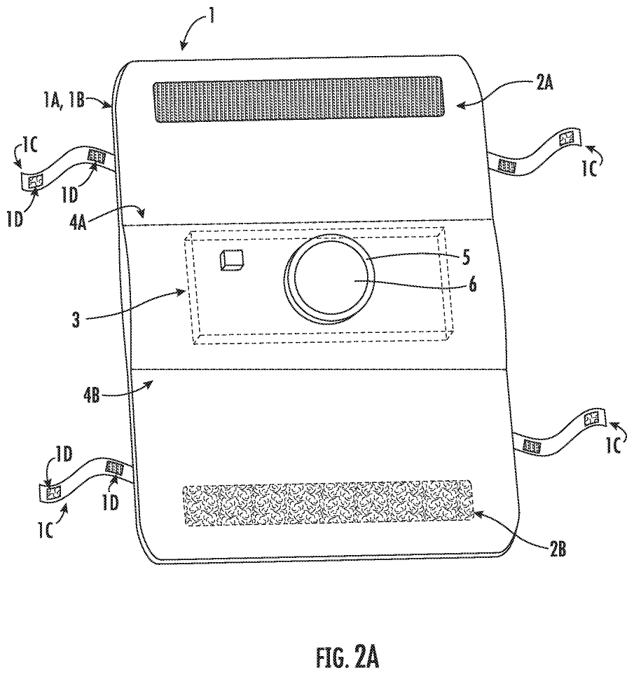

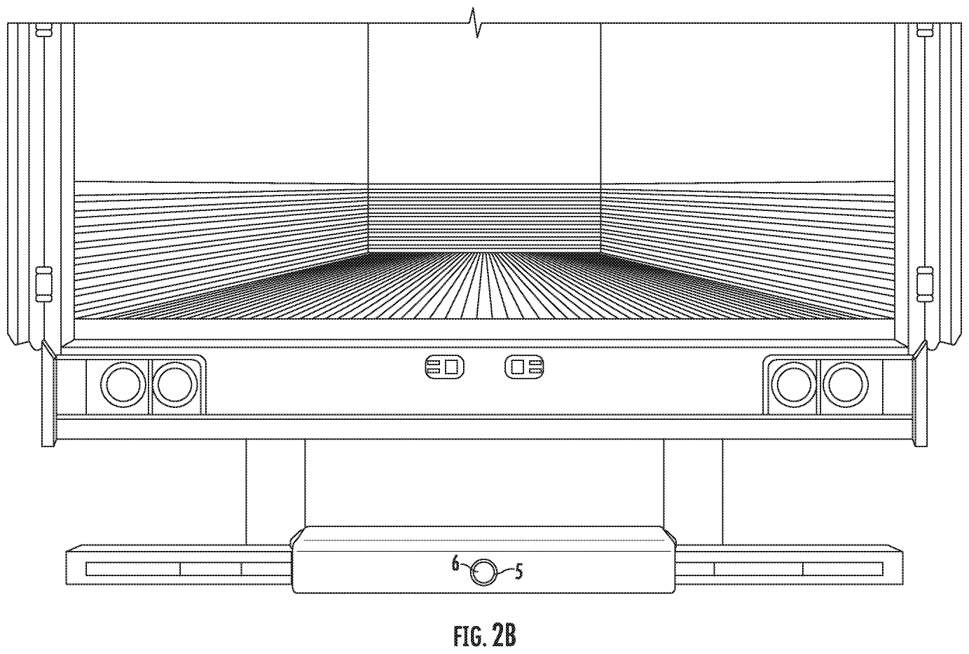

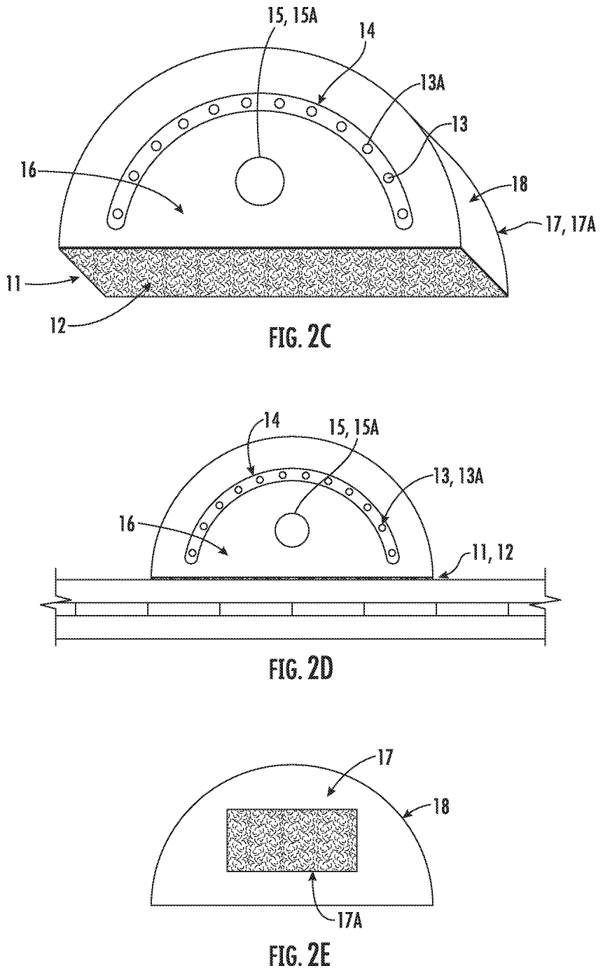

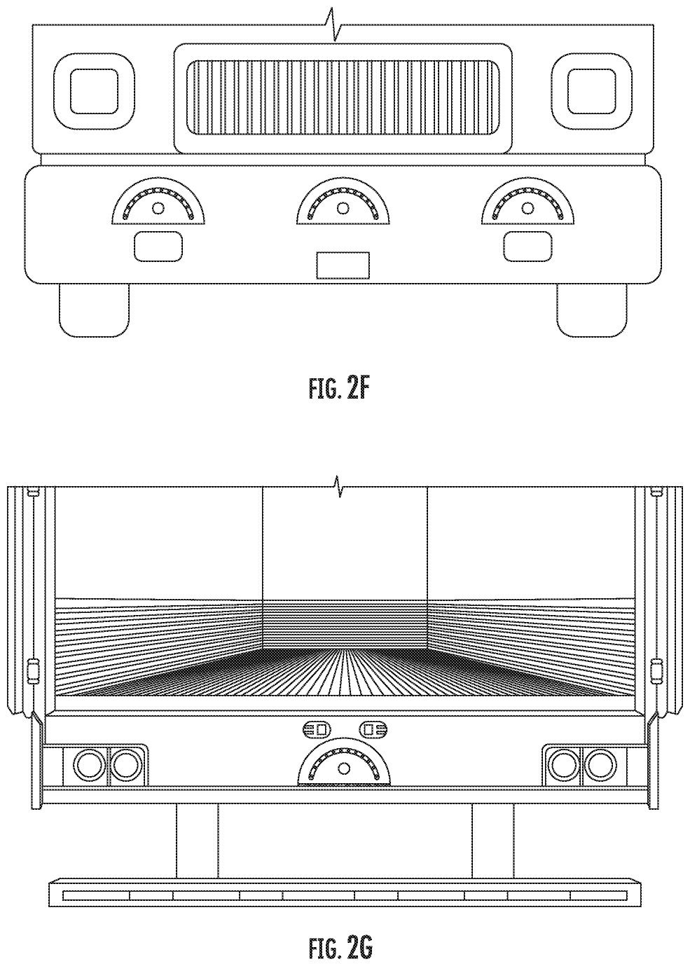

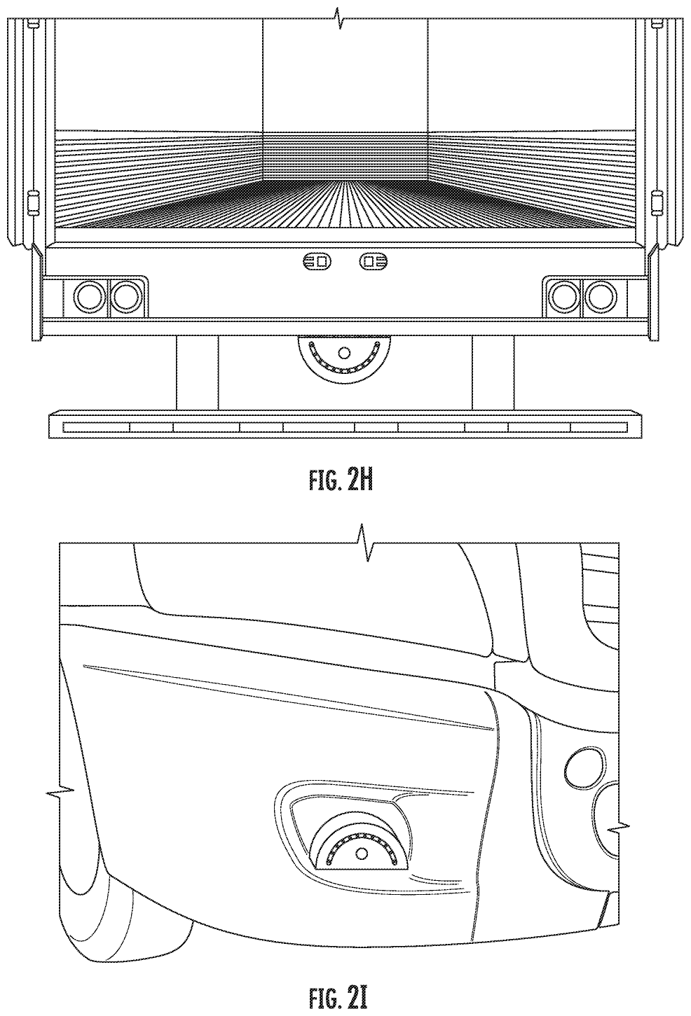

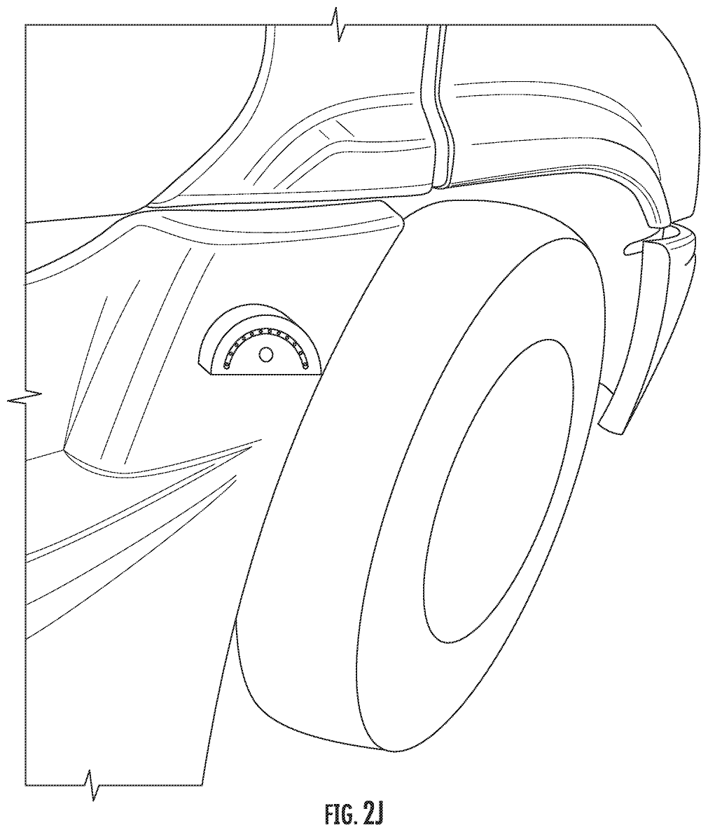

FIG. 2A presents a top view of a Sneaky Peek mount formed as a wrapping frame as taught in an embodiment disclosed herein. A Sneaky Peek mount 1 is most generally a device having a mechanism by which it is attachable to the members of the rear guard of a truck trailer and that has a communication system embedded therein. This communication system within the Sneaky Peek mount 1 enables bi-directional transmission of information and control signals to an electromagnetically linked transmitter/receiver held by the truck driver at the front of the truck in his or her cab. Thus, a truck driver is able use his transmitter/receiver to access the Sneaky Peek mount 1 communication system and control the video reception therefrom and transmission of this data back to his transmitter/receiver.

In the particular exemplary embodiment of FIG. 2A, there are two rectangular pieces a first rectangular piece 1A, a second rectangular piece 1B of nylon material sewn about their respective peripheries thereby engaging them together. The two of these together form a truck rear guard wrapping frame. This wrapping frame whilst preferably disclosed as nylon can be made of pieces of cloth material such as cotton, nylon, leather, linen, artificial and or natural materials.

Additionally, the wrapping frame can alternatively be made from segmented pieces of plastic having thinner links between adjacent strips of plastic to permit the wrapping about the rear guard member. To wrap the frame to the truck the top portion of the figure is a first strip of velcro material 2A attached by sewing to the top surface of a first rectangular material 1A; at the bottom portion of the figure is a second strip of velcro material 2B attached by sewing to the bottom surface of a second rectangular material 1B.

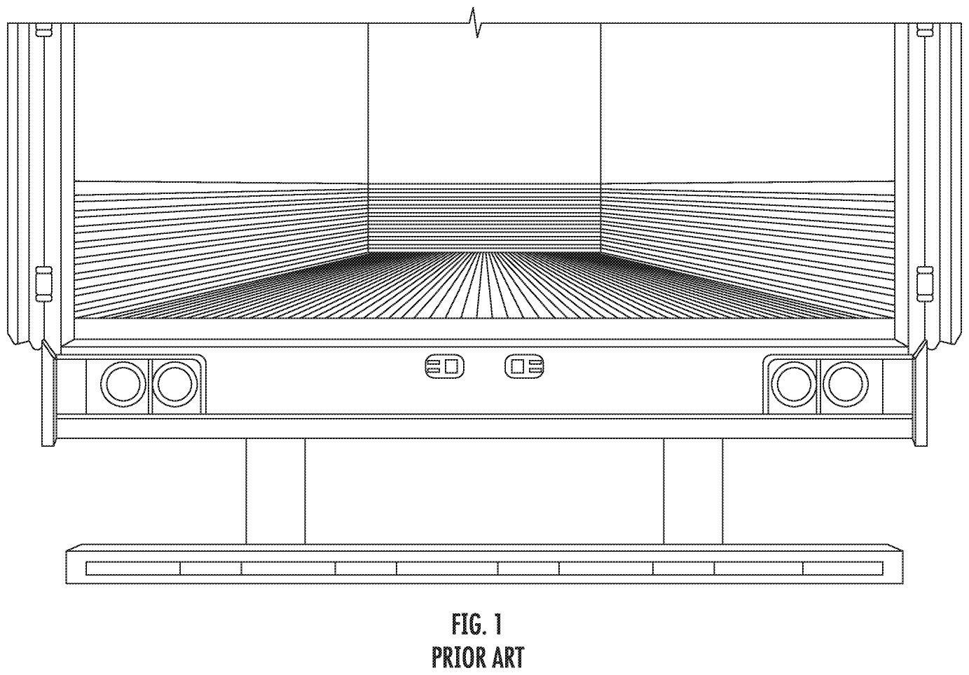

Thus, this second strip of material 2B shown in dotted silhouette lines is designed to attach atop the first strip of material 2A when the Sneak Peek mount 1 is wrapped about the rear guard of a truck. Typically, a user would place the bottom surface of the second strip of material 1B about the horizontal member of a rear guard shown in FIG. 1 (or some similar other member at the rear of the truck trailer). Then he would wrap the mount about the rear guard member (or other similar member) and engage the two strips of velcro by positioning the second strip of material 2B shown in dotted silhouette lines atop the first strip of material 2A and thereby engaging the velcro material of these two together.

It should be apparent that the engagement mechanism described herein can be substituted with numerous convenient fastener alternatives such as buttons, snaps, links, jewelry hooks, carabiner type locking mechanisms and so forth and the instant disclosure should not be limited to the specific implementation described herein but given the full measure due as discussed in the claims.

Finally, a Sneaky Peek module 3 is sewn into a cavity between a top sewing line 4A and a bottom sewing line 4B (between 1A-1B) which forms a compact cavity for the electronic module. The Sneaky Peek module 3 is disposed in a cavity between the first rectangular piece of material 1A and the second rectangular piece of material 1B. Other sewing lines between the aforementioned are added as necessary to effect a rigid engagement of the Sneaky Peek module 3 within the carrier 1. The Sneaky Peek module is generally a plastic housing having various molded depressions for housing a circuit board, rechargeable battery(-ies), a USB or barrel connector port, antenna, and camera (with similar cutouts in 1A, 1B therefore).

The camera sits within a part of the Sneaky Peek module 3 having a hole therein facing outwards. This hole has a corresponding hole in either of the first rectangular piece of material 1A or the second rectangular piece of material 1B as needed. The material of either one of the aforementioned having this hole is affixed by glue or adhesives to the surface of the Sneaky Peek module 3 about the camera so that this material does not pull away causing damage to the external surface thereof. Thus, the camera disposed in this fashion can visualize activity from a unique vantage point.

Alternatively, in the event a user has the desire to replace a battery, a small removable door or hinged flap is disposed within the package to enable access to the battery(-ies) so as to remove them therefrom and replace the aforementioned along with appropriate velcro flap having a portion of the nylon surface of 1A or 1B for this purpose. Preferably, however, the first way is best, that is, to use a recharging system with USB port or barrel port that cooperates with USB connector or barrel connector & transformer.

FIG. 2B presents a rear view of a trailer of the Sneaky Peek mount formed as a wrapping frame as taught in an embodiment disclosed herein wrapped about a rear guard of a truck or semi.

FIG. 2C presents a front perspective view of a Sneaky Peek mount formed as a rigid housing in an alternative embodiment disclosed herein. The rigid housing of the Sneaky Peek mount has a bottom surface 11, a front surface 16, a rear surface 17 and an intermediate surface 18. The bottom surface 11 integrates with the front surface 16 along a forward common edge. Similarly, the bottom surface 11 integrates with the rear surface 17 along a rear common edge. Next, the bottom surface 11 integrates with the intermediate surface 18 along a left common edge as well as along a right common edge. Finally, the front surface 16 integrates with the intermediate surface 18 along a curved common edge and the rear surface 17 integrates with the intermediate surface along a curved common edge. These are connected with molded connectors (depression tongue, arrowhead to depression), screws to threaded mounts, glue, adhesives or similar modalities.

It should be appreciated from the figure that the Sneaky Peak rigid housing shown in FIG. 2C could be in any suitable form such as a pyramid, square shape, hexagonal, and so forth, but has been shown in a semi-circular wedge shape. Thus, the circumference of the circle (arc, curved surface or similar shape) continues backwards along the intermediate surface 18 using the bottom surface 11 formed as a rectangular bottom guide to bound the shape of the wedge. Attached to this bottom surface 11 is a first side of double sided first piece of material 12 having adhesive on its first side and velcro on its second side. This second side having velcro is used to attach to a trailer bumper, truck bumper or similar portion of a vehicle having a similar double sided second piece of material having corresponding velcro on one side and adhesive on its other side so as to permanently affix this second piece of material to a truck bumper, trailer bumper or other vehicle portion.

Further, an electronics circuit board Sneaky Peek module 3 has been placed within the Sneak Peek housing upon the inner top of the bottom surface 11 and is attached thereto with adhesives or integrally formed as part of the inner portion of the bottom surface 11. The Sneaky Peek module 3 has the circuit board, wiring, battery and other necessary components therein to effect the operation of the various functions as described herein. The Sneaky Peek module 3 is accessible via the rear surface 17 that attaches to the intermediate surface 18 using screw holes (not shown, alternatively molded arrowheads with depressions) in the rear surface 17 having integrally formed corresponding threaded screw mounts (not shown) formed integrally inside the Sneaky Peek housing intermediate surface 18.

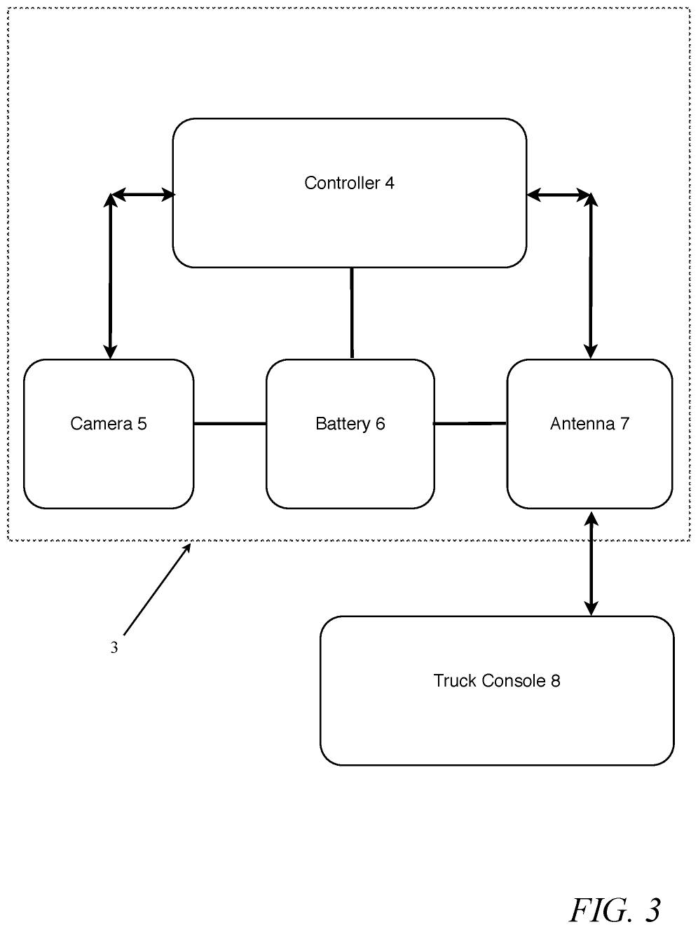

The Sneaky Peek Module 3 is also attached to wires (or a dedicated wiring harness—not shown) that are disposed in optional plastic guides (not shown) formed within the inner surface of the housing to guide these wires to attach appropriately to various LEDs 13; these LEDs 13 are themselves mounted within integrally formed appropriate LED holders (not shown) on the inner surface of the front surface 16 and thereby permit the aforementioned to exit through various holes 13A on the front surface 16 of the housing. The front surface 16 has a reflective depression 14 coated with reflective material (or reflective material adhesively mounted thereon as a separate part, e.g., aluminum attachment) running in a curved or arc shape along the same path as the holes 13A and LEDs 13. The camera 15 is formed in a hole 15A in the front surface 16 of the housing and attached appropriately to the module 3 therein. The module 3 can actuate the LEDs as appropriate through a user activating a truck console icon that facilitates turning ON and OFF the LEDs as appropriate. Any appropriate glue logic such as resistors (NOT SHOWN) are included in the circuit shown below in FIG. 3. Alternatively, a manual button on the housing can facilitate the activation of the LEDs using parallel circuitry (NOT SHOWN).

FIG. 2D presents a front view of a Sneaky Peek mount formed as a rigid housing attached by velcro 12 on the bottom of the rigid housing to the top of a back bumper of a trailer already having attached a double sided strip of adhesive/velcro using the adhesive side to attach it to the back bumper thereto with the velcro sides attached one to another in an alternative embodiment disclosed herein.

FIG. 2E presents a back view of a Sneaky Peek mount formed as a rigid housing having a velcro strip attached to the back of the rigid housing in an alternative embodiment disclosed herein. This system uses a first double sided piece of material having adhesive on one side and velcro on the other. In order to accomplish this, a first double sided strip of material is attached to a truck front bumper (or other portion of a vehicle) using adhesive on one side thereof to attach the first double sided strip of material to the front bumper of the truck. The velcro side is used to attach to a corresponding second piece of double sided material having 17 A velcro on one side thereof and adhesive on the other. This second piece of material is attached to the rear surface 17 of the Sneak Peek mount alternative embodiment housing using the adhesive side thereof.

FIG. 2F presents a view of the Sneak Peek mount formed as a rigid housing having a velcro side/adhesive side double sided strip attached to the back of the rigid housing using the adhesive as it attaches to a front of a truck bumper in an alternative embodiment disclosed herein. This system uses a first double sided piece of material having adhesive on one side and velcro on the other. In order to accomplish this, a first double sided strip of material is attached to the truck front bumper using adhesive on one side thereof to attach the strip of material to the front bumper of the truck. The velcro side is used to attach to a corresponding second piece of material having velcro on one side thereof and adhesive on the other. This second piece of material is shown in FIG. 2E and is attached to the back of the Sneak Peek mount alternative embodiment housing using the adhesive side thereof.

FIG. 2G presents a view of the Sneak Peek mount formed as a rigid housing having two double sided velcro (first side)/adhesive (second side) strips attached using the respective adhesive sides one to the back and one to the bottom of the rigid housing; this as it attaches to a rear of a trailer and to a ledge underneath a set of doors in an alternative embodiment disclosed herein using a third and fourth piece of material. A third double sided piece of material having velcro (first side)/adhesive (second side) uses the adhesive to attach it to a ledge at rear of truck and velcro on its other side to attach to underside of Sneaky Peak housing having velcro thereon. A fourth double sided piece of material having velcro (first side)/adhesive (second side) uses the adhesive on one side to attach it to a rear of a truck above a ledge and velcro on its other side to attach to back side of Sneaky Peak housing having velcro thereon.

FIG. 2H presents a view of the Sneak Peek mount formed as a rigid housing having a velcro side/adhesive side double sided strip attached to the bottom of the rigid housing using the adhesive as it attaches to an underside of the rear of a trailer in an alternative embodiment disclosed herein. Another double sided piece of material having adhesive to attach it under a ledge at rear of truck and velcro on its other side to attach to underside of Sneaky Peak housing having velcro thereon with Sneaky Peak housing inverted.

FIG. 2I presents a view of the Sneak Peek mount formed as a rigid housing having a velcro side/adhesive side double sided strip attached to the back of the rigid housing using the adhesive as it attaches to a depression in the front bumper of a truck in an alternative embodiment disclosed herein. Another double sided piece of material having adhesive to attach it to a depression in a front truck bumper and velcro on its other side to attach to back of Sneaky Peak housing having velcro on its back.

FIG. 2J presents a view of the Sneak Peek mount formed as a rigid housing having a velcro side/adhesive side double sided strip attached to the back of the rigid housing using the adhesive side as it attaches to a side panel of a truck in an alternative embodiment disclosed herein. Another double sided piece of material having adhesive to attach it to a side panel of truck and velcro on its other side to attach to back of Sneaky Peak housing having velcro thereon.

FIG. 3 presents a high level view of the Sneaky Peek electronic module that is disposed within the Sneaky Peek Mount or housing of FIG. 2A-2J as taught in an embodiment herein disclosed. The Sneaky Peek module 3 is shown in a high level diagram generally comprising: a controller 4, a camera 5, a battery pack 6, and an antenna 7. It should be apparent that the battery pack 6 is connected through appropriate circuitry to the controller 4, camera 5, and the antenna 7 in order to enable their proper functioning; LEDs (NOT SHOWN) are also connected to the battery pack 6 and the controller 4 in the alternative embodiment shown in FIG. 2C-2J so as to actuate LEDs as appropriate. The controller 4 controls operation of the camera 5 and transmits ON/OFF commands thereto and receives VIDEO data therefrom and any other appropriate data and control signals are transmitted there between for the proper functioning of the system.

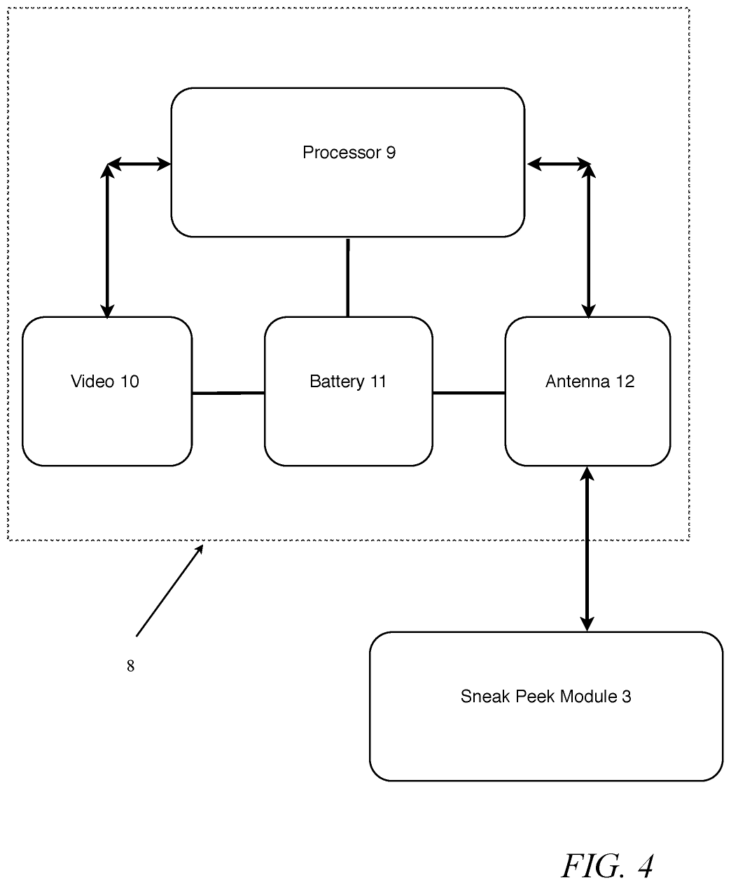

This VIDEO data, Sneaky Peek module 3 Status and other information, is processed by controller 4 and formatted for transmission across Wi-Fi®, BLUETOOTH®, RF communication using antenna 7 or similar medium to a truck console 8. The controller encodes the information along with appropriate control, synch, session, encryption, and error correction codes and actuates the antenna 7 for direct communication to the end user at truck console 8. The truck console can be a standalone device in a plastic housing with dedicated software/firmware; specialized software loaded into a tablet; an app in a mobile smart phone or similar implementation. In particular, in an app of a mobile phone, the app when user activated uses the OS of the phone to activate the particular mobile antenna to communicate with the Sneaky Peek module and set up a video session. Various general components are shown more particularly with regards to FIG. 4.

FIG. 4 presents a high level view of the Truck Console that communicates with the Sneaky Peek Module as taught in an embodiment herein disclosed. The Truck Console 8 communicates with the Sneaky Peek module 3 across a medium through wireless access to the antenna 12 of the truck console 8. The Truck Console 8 is shown in a high level diagram generally comprising: a processor 9, a video display 10, a battery pack 11, and an antenna 12. It should be apparent that the battery pack 11 is in communication through appropriate circuitry to the processor 9, video display 10, and the antenna 12 in order to enable their proper functioning. The processor 9 controls operation of the video display 10 and transmits ON/OFF commands thereto and transmits VIDEO data thereto and any other necessary data is transmitted there between for the proper functioning of the system.

This VIDEO data, Sneaky Peek module 3 Status and other information, is first received by antenna 12 that has been transmitted using Wi-Fi®, BLUETOOTH®, RF communication or similar medium to the truck console 8. The processor 9 decodes the information along with appropriate control, synch, session, encryption, and error correction codes and actuates the antenna for direct communication with the Sneaky Peek module 3. The truck console can be a standalone device in a plastic housing with dedicated software/firmware; specialized software loaded into a tablet; an app in a mobile smart phone or similar implementation.

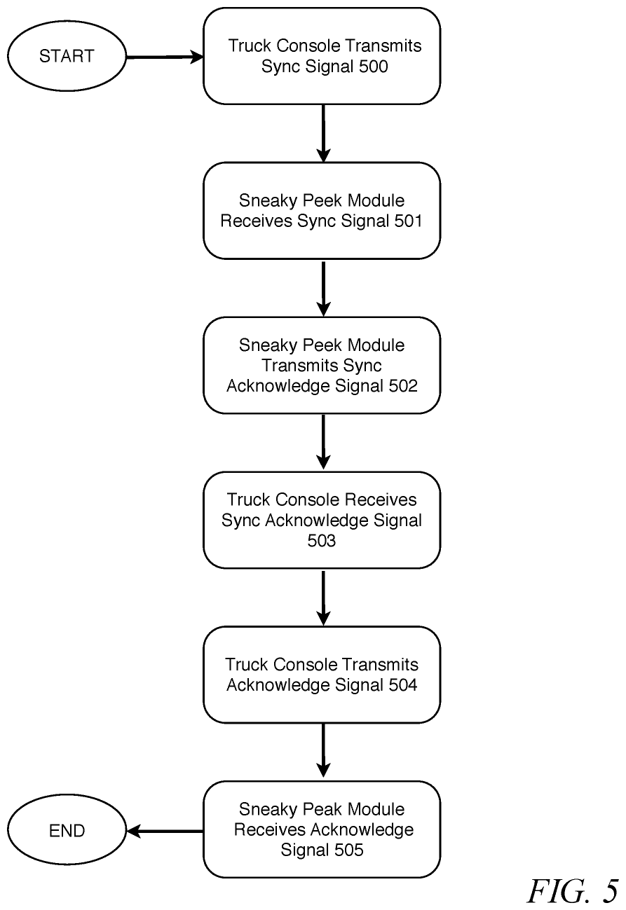

FIG. 5 presents a high level flowchart of the various steps involved in initiating communication between the Sneaky Peek and the Truck Console as taught in an embodiment herein disclosed. It should be understood that the Sneaky Peek module has a hard ON/OFF button and a soft ON/OFF software power down system to conserve power. Thus, a user presses the hard physical ON/OFF button to energize the Sneaky Peek module and leave it capable of receiving commands from the truck console. After a certain amount of time it can self power down and wait for the truck console to transmit activation commands to power up using a software ON command. Thus, the Sneaky Peek module is commanded by software to activate by powering a soft ON from a pre-existing soft OFF command and begin the synchronization process.

The process of synchronizing the Sneaky Peek module with the Truck Console STARTs with the Truck Console transmitting 500 a synchronization signal when a user presses a button embedded (APP ICON in a mobile app) with the Truck Console device activating the link between the two devices. Next, the Sneaky Peek Module Receives 501 the Synchronization signal. The Sneaky Peek module then transmits a synchronization acknowledge signal 502 back to the Truck Console. At this point the Truck Console receives 503 the synchronization acknowledge signal. As a result, the Truck Console transmits an acknowledgement signal 504 to the Sneaky Peek module who receives the aforementioned 505.

It should be apparent that this is a three step synchronization protocol for initializing communication between the Truck Console and the Sneaky Peek Camera at the rear of the truck. First a SYNC signal is sent from the Truck Console, then a SYNC ACK signal is returned from the Sneaky Peek and then the Truck Console transmits an ACK signal. Of course any type of protocol can be used to initialize a session of video transmission between the two. Once a communication session is established, then video transmission is possible. The particular software is to effect these commands is stored in onboard separate memor(-ies) (Not Shown) connected to one or the other batter(-ies) 6 or 11 and to the controller 4 or processor 9 respectively as appropriate; or on integral memories of controller 4 or processor 9 respectively as appropriate. The controller 4, processor 9 can alternatively represent a cpu, a gpu or a combination of the foregoing. Similarly, video data can be temporarily stored in separate onboard memories (Not Shown) or within integral memories as described above.

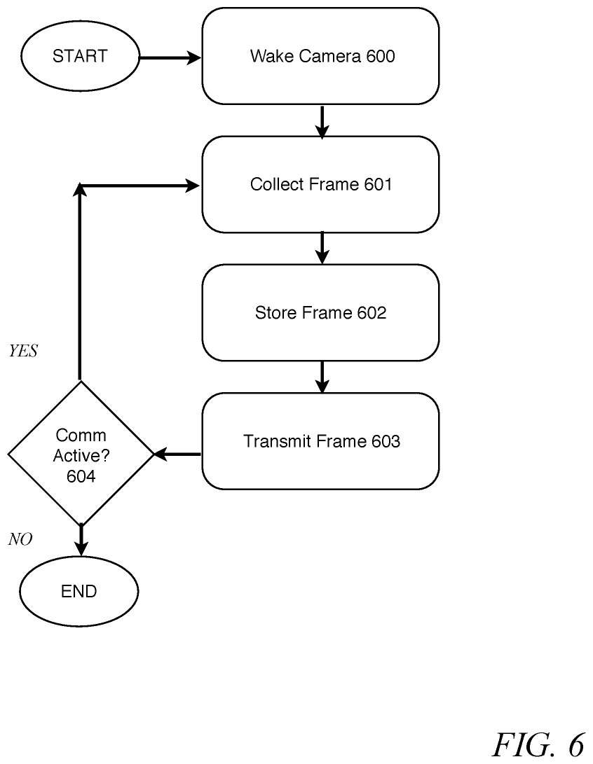

FIG. 6 presents a high level flowchart of the various steps involved in gathering images at the Sneaky Peek and preparing them for transmission to the Truck Console as taught in an embodiment herein disclosed. Since communication is now possible the process STARTs with the Sneaky Peek Module waking the camera 600 which initialized itself and in turn collects a frame of image data 601. The frame is stored 602 by the Sneaky Peek controller in an onboard memory (or integral with controller) appropriately connected to battery pack associated with the Sneaky Peek controller (not shown). Finally, the Sneaky Peek controller transmits 603 the frame of image data to the Truck Console. At this point a determination 604 is made as to whether or not communication is still active. Communication can be stopped by the user at the Truck Console depressing a physical button (hard OFF or STOP) thereon that stops the functioning thereof severing the link between the two; alternatively, a software stoppage by closing an app or other type of software. This button can be implemented electro-mechanically with a button connected via electronics to appropriate sensors within glue logic to the processor of the Truck Console; this can also be implemented by a touch pad having active menus for selecting the activation or deactivation of the video communication. In any case, if communication has been severed then the process ends. If communication is still active then the process repeats collect frame 601, store frame 602, transmit frame 603 and COMM Active 604 and repeat.

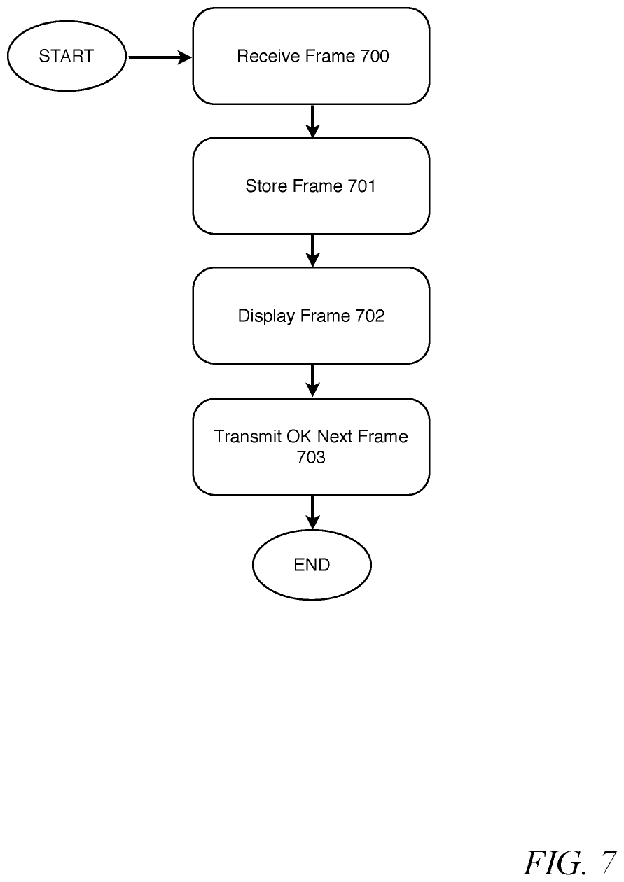

FIG. 7 presents a high level flowchart of the various steps involved in receiving images at the Truck Console and Displaying the aforementioned as taught in an embodiment herein disclosed. The Truck Console receives data 700 at its antenna from the Sneaky Peek module antenna. The frame of visual data is temporarily stored 701 in an onboard memory of the Truck Console or integral memory of the processor. The Truck Console processor then commands the VIDEO 10 device to display a frame of data 702. At this point the Truck Console processor commands the antenna to transmit an OK next frame command to the the Sneaky Peek module which will in turn continue transmitting data as a result.

Thus, a removably attachable Sneaky Peek Housing and Module have been described that communicates video information to a truck console. Additionally, the communication system is intended to be used in any type of electromagnetic communication medium using appropriate antenna therefore but especially in WIFI, RF and similar types of communication as described herein. The foregoing represents a broad implementation of the various principles herein disclosed and numerous modifications of these can be contemplated without departing from the spirit and scope of the invention which is defined by the following claims.

1. A vehicle camera carrier comprising:
a housing having:
a camera rigidly disposed within the housing along with an associated controller such that the camera is positioned at a front surface of the housing through a hole therein, thereby exposing a part of the camera; wherein the housing is removably attachable to a portion of a vehicle and wherein the housing is not an original integral portion of the vehicle;
a reflector attached to the front surface of the housing nearby the exposed part of the camera; wherein the housing further comprises:
a front surface;
a bottom surface integrates with the front surface along a forward common edge;
a back surface integrates with the bottom surface along a rear common edge; and
an intermediate surface such that the intermediate surface integrates the front surface with the back surface and wherein the intermediate surface integrates with the bottom surface thereby rigidly forming the vehicle camera carrier housing;
such that the bottom surface integrates with the intermediate surface along a right common edge and a left common edge; and
such that the front surface integrates with the intermediate surface along a first common curved edge and the back surface integrates with the intermediate surface along a second curved common edge.

2. A vehicle camera carrier comprising:
a housing formed from flexible material having:
a camera rigidly disposed within the housing along with an associated controller; wherein the housing is removably attachable to a portion of a vehicle and wherein the housing is not an original integral portion of the vehicle;
wherein the housing is a wrapping frame having an integral top surface and an integral bottom surface wherein the top surface and the bottom surface are integral with one another and face in opposite directions;
a first fastener attached at the top surface of the wrapping frame and a second fastener attached to a bottom surface of the wrapping frame; characterized in that the first fastener engages the second fastener when the wrapping frame is wrapped completely about a portion of a vehicle system.

3. The vehicular camera carrier of claim 2, wherein the first fastener further comprises a fastener from a set of fasteners of: a button, a piece of velcro, a snap, links, jewelry hooks, carabiner type locking mechanisms.

4. The vehicular camera carrier of claim 1, further comprising:
a controller mounted in the housing in communication with the camera.

5. The vehicular camera carrier of claim 1, further comprising:
a battery mounted in the housing in communication with the camera.

6. The vehicular camera carrier of claim 1, further comprising:
an antenna mounted in the housing in communication with the camera.

7. The vehicular camera carrier of claim 6, wherein the antenna is from a set of antennas: a Wi-Fi® antenna, a BLUETOOTH® antenna, an RF antenna.

8. (canceled)

9. (canceled)

10. (canceled)

11. (cancelled)

12. (cancelled)

13. (cancelled)

14. (cancelled)

15. (cancelled)

16. (cancelled)

17. (cancelled)

18. (cancelled)

19. (cancelled)

20. (cancelled)

21. The vehicle camera carrier of claim 1, further comprising:
a light attached to the housing through the reflector and associated with a controller in the housing that is in electronic communication with the camera.

22. The vehicle camera carrier of claim 21, wherein the light further comprises:
an LED.

23. The vehicle camera carrier of claim 21, wherein the light further comprises:
a plurality of LEDs.

24. The vehicle camera carrier of claim 1, wherein the reflector further comprises:
an arc shaped reflector.

25. The vehicle camera carrier of claim 1, wherein the reflector further comprises:
a curved shaped reflector.

26. The vehicle camera carrier of claim 1, wherein the reflector further comprises:
a depression on a front surface of the housing.

27. A vehicle camera carrier housing comprising:
a front surface;
a bottom surface integrates with the front surface along a forward common edge;
a back surface integrates with the bottom surface along a rear common edge; and
an intermediate surface such that the intermediate surface integrates the front surface with the back surface and wherein the intermediate surface integrates with the bottom surface thereby rigidly forming the vehicle camera carrier housing;
such that the bottom surface integrates with the intermediate surface along a right common edge and a left common edge; and
such that the front surface integrates with the intermediate surface along a first common edge and the back surface integrates with the intermediate surface along a second common edge;
wherein a first piece of material is attached to a first portion of the housing such that the first piece of material has velcro on an exposed side thereof;
a camera rigidly disposed within the housing along with an associated controller; wherein the housing is removably attachable to a vehicle and wherein the housing is not an original integral part of the vehicle.

28. The vehicle camera carrier housing of claim 27, further comprising:
a second piece of material attached to a second portion of the housing such that the second piece of material has velcro on an exposed side thereof.

29. The vehicle camera carrier housing of claim 28, wherein the first portion of the housing is the bottom surface and the second portion of the housing is the back surface; characterized in that the first piece of material is thereby attachable to a vehicular system first surface having a corresponding piece of velcro material attached thereto and the second piece of material is thereby attachable to a vehicular system second surface having different spatial characteristics than the first surface.

30. The vehicle camera carrier housing of claim 28, wherein the first portion of the housing is the back surface and the second portion of the housing is the bottom surface; characterized in that the first piece of material is thereby attachable to a part of a vehicular system first surface having a corresponding piece of velcro material attached thereto and the second piece of material is thereby attachable to a vehicular system second surface having different planar orientation than the first surface.

31. The vehicle camera carrier of claim 2, further comprising: such that the first fastener and the second fastener are on opposite sides of the camera when unwrapped as they are on the top and bottom surfaces respectively which are on opposite sides of the camera; and when wrapped together the change in orientation caused by engagement of the first and second fasteners causes them to be on the same side of the camera when viewed therefrom.

32. The vehicle camera carrier of claim 2, further comprising:
the camera is disposed in the center region of the guard wrapping frame such that the first fastener and the second fastener are on opposite sides of the camera as they are characterized in that the first fastener is attached to the top surface and the second fastener is attached to the bottom surface so that the top surface is opposite the bottom surface when laid flat as when the guard wrapping frame is unwrapped; and on the same side of the camera when engaged together as the wrapping to engage the first and second fasteners together wraps the entire frame together changing the orientation of the top surface first fastener so that it engages the bottom surface second fastener thereby connecting these on the same side of the camera when viewed therefrom.
